(19) United States
(12) Patent Application Publication
(10) Pub. No.: US 2009/0315675 A1
(43) Pub. Date: Dec. 24, 2009

(54) Information Processing Device and Indication Control Method

(75) Inventor: Ryuhei Yokota, Tachikawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/366,423

(22) Filed: Feb. 5, 2009

(30) Foreign Application Priority Data
Jun. 23, 2008 (JP) 2008-163772

(51) Int. Cl. G08B 29/00

(52) U.S. Cl. 340/5.83

(57) ABSTRACT

According to one embodiment, an information processing device includes a fingerprint sensor installed in the housing, a first and second indicator modules installed in the housing, a determination module configured to control the first indicator module to change indication patterns according to whether the fingerprint sensor is usable, and determine verification of an authentication entry upon detection of the authentication entry to the fingerprint sensor while the fingerprint sensor is usable, and a control module configured to control the second indicator module to change an indication pattern when the authentication entry has been verified by the determination module.

### CROSS-REFERENCE TO RELATED APPLICATIONS

This application is based upon and claims the benefit of priority from Japanese Patent Application No. 2008-163772, filed Jun. 23, 2008, the entire contents of which are incorporated herein by reference.

### BACKGROUND

1. Field

One embodiment of the present invention relates to a technique of controlling an information processing device comprising a fingerprint sensor and, more particularly, to an information processing device and an indication control method capable of causing an indicator device to indicate operation states of the fingerprint sensor.

2. Description of the Related Art

In general, a personal computer comprising a fingerprint sensor determines whether to allow a user to use the personal computer by means of fingerprint authentication. Such a personal computer cannot be used until the authenticated fingerprint is verified. Jpn. Pat. Appln. KOAKI Publication No. 2000-315120, for example, discloses a LED indicator device which indicates whether or not the fingerprint has been authenticated, and indicates whether or not the authenticated fingerprint has been verified.

In the technique disclosed in Jpn. Pat. Appln. KOKAI Publication No. 2000-315120, however, a user cannot know whether the fingerprint sensor is operated or not prior to the fingerprint authentication, i.e., in a state where the personal computer cannot be used. Therefore, a user cannot know whether the fingerprint sensor is operated or not until making an operation to swipe his or her finger through the fingerprint sensor, for example.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an exemplary outer appearance of an information processing device according to an embodiment of the present invention.

FIG. 2 is an exemplary block diagram showing a main configuration of the information processing device according to the embodiment.

FIG. 3 is an exemplary block diagram showing a main configuration of a fingerprint sensor IC according to the embodiment.

FIG. 4 is an exemplary flowchart illustrating an indication control method of the information processing device according to the embodiment.

FIG. 5 is an exemplary conceptual diagram illustrating LED indication patterns of the information processing device according to the embodiment.

FIG. 6 is an exemplary conceptual diagram illustrating LED indication patterns of the information processing device according to the embodiment.

FIG. 7 is an exemplary flowchart illustrating an indication control method of the information processing device according to the embodiment.

### DETAILED DESCRIPTION

Various embodiments according to the invention will be described hereinafter with reference to the accompanying drawings. In general, according to one embodiment of the invention, an information processing device includes: a fingerprint sensor installed in the housing; a first and second indicator modules installed in the housing; a determination module configured to control the first indicator module to change indication patterns according to whether the fingerprint sensor is usable, and determine verification of an authentication entry upon detection of the authentication entry to the fingerprint sensor while the fingerprint sensor is usable; and a control module configured to control the second indicator module to change an indication pattern when the authentication entry has been verified by the determination module.

Hereinafter, an embodiment of the present invention will now be described with reference to the drawings.

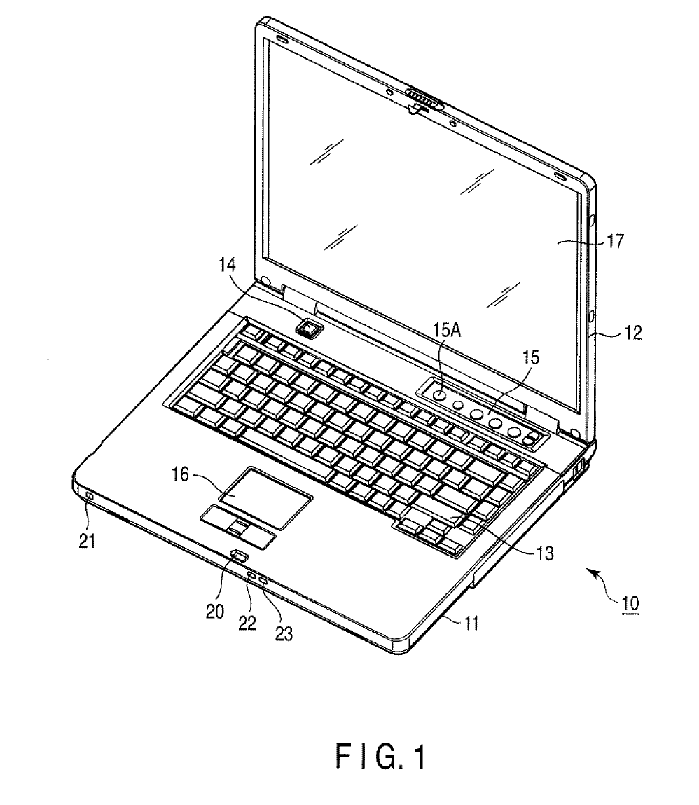

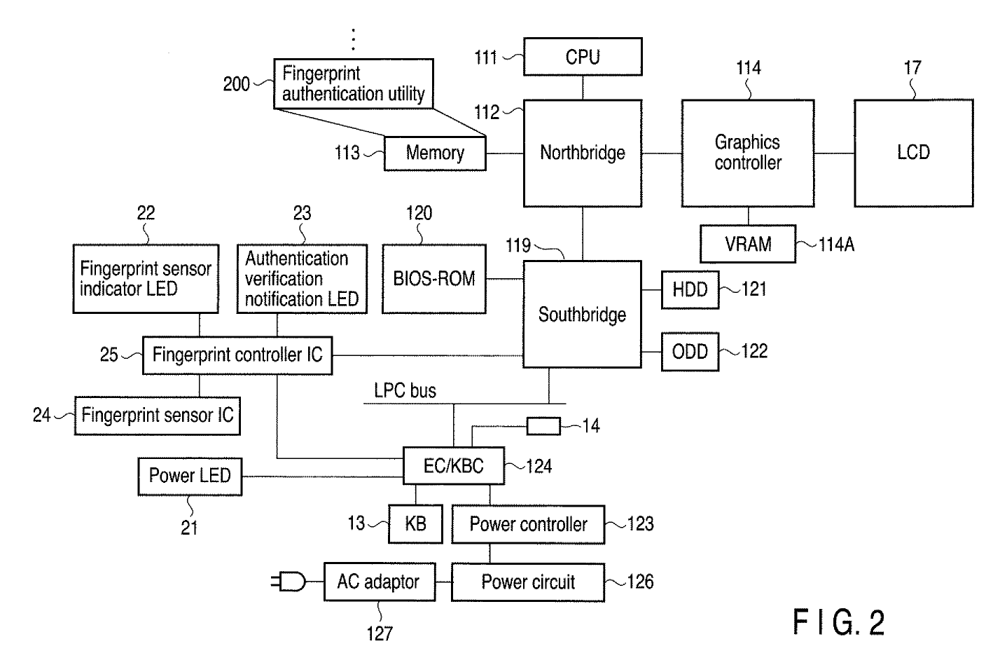

First, the configuration of the information processing device according to an embodiment of the present invention will be described with reference to FIGS. 1 and 2. The information processing device is realized as a notebook computer 1, for example.

FIG. 1 is a perspective view of a notebook computer 10 in a state where a display unit is open. The computer 10 is formed of a computer body 11 and a display unit (lid) 12. The display unit 12 includes a display device embedded therein and formed of a liquid crystal display (LCD) 17. A display screen of the LCD 17 is positioned approximately in the center of the display unit 12.

The display unit 12 is attached to the computer body 11 to be swingable between open and closed positions. The computer body 11 has a thin-box-shaped housing. On a top surface of the housing 11, a power button 14 for turning on/off the computer 10, an input operation panel 15, a DVD playback software activation button 15A, a touchpad 16, a fingerprint sensor 20, a power LED 21, a fingerprint sensor indicator LED 22, and an authentication verification notification LED 23, for example.

The fingerprint sensor 20 becomes usable when a user swipes his or her finger through the fingerprint sensor 20 to register the fingerprint. The fingerprint sensor 20 is used for authentication on booting the computer 10 (imaging mode) and scrolling on software (navigation mode), for example. The power LED 21 is an indicator indicating whether the computer 10 is turned on or off. The fingerprint sensor indicator LED 22 indicates whether the fingerprint sensor 20 is operated or not by means of colors (such as green and red) of the LED and blinking, for example. The authentication verification notification LED 23 indicates whether the authenticated fingerprint has been verified or not (match or mismatch) by means of colors (such as green and red) of the LED and blinking, for example.

Next, the system configuration of the portable computer 10 will be described below with reference to FIG. 2.

As shown in FIG. 2, the portable computer 10 comprises a CPU 111, a north bridge 112, a (main) memory 113, a graphics controller 114, a south bridge 119, a BIOS-ROM 120, a hard disk drive (HDD) 121, an optical disk drive (ODD) 122, an embedded controller/keyboard controller IC (EC/KBC) 124, the power LED 21, a fingerprint controller IC determination module, control module) 25, a fingerprint sensor IC 24, the fingerprint sensor indicator LED (first indicator module) 22, the authentication verification notification LED (second indicator module) 23, a power controller 123, a power circuit 126, and an AC adaptor 127, for example.

The CPU 111 is a processor provided to control the operation of the computer 10, and executes various application programs loaded from the hard disk drive (HDD) 121 to the memory 113, such as an operating system (OS) and a fingerprint authentication utility 200.

Further, the CPU 111 reads and executes a system Basic Input/Output System (BIOS) stored in the BIOS-ROM 120. The system BIOS is a program for controlling hardware.

The north bridge 112 is a bridge device which connects a local bus of a CPU 111 and the south bridge 119. The north bridge 112 also includes a built-in memory controller which controls access of the memory 113. The north bridge 112 also has a function of performing communications with the graphics controller 114 via an Accelerated Graphics Port (AGP) bus, for example.

The graphics controller 114 is a display controller which controls the LCD 17 used as a display monitor of the computer 10. The graphics controller 114 generates a display signal to be transmitted to the LCD 17 based on image data written into a video memory (VRAM) 114A.

The south bridge 119 controls devices on a Low Pin Count (LPC) bus and devices on a Peripheral Component Interconnect (PCI) bus. Further, the south bridge 119 is provided with a built-in Integrated Drive Electronics (IDE) controller for controlling the HDD 121 and the ODD 122. The south bridge 119 also has a function of controlling the fingerprint controller IC 25 and the BIOS-ROM 120.

The HOD 121 is a storage device which stores various kinds of software and data. The optical disk drive (ODD) 122 is a drive unit configured to drive storage media such as DVDs in which video contents are stored.

The embedded controller/keyboard controller IC (EC/KBC) 124 is a one-chip microcomputer in which an embedded controller for power management and a keyboard controller for controlling the keyboard (KB) 13 and the touchpad 16 are integrated The embedded controller/keyboard controller IC (EC/KBC) 124 has a function of turning on/off the computer 10 according to the operation of the power button 14 by a user.

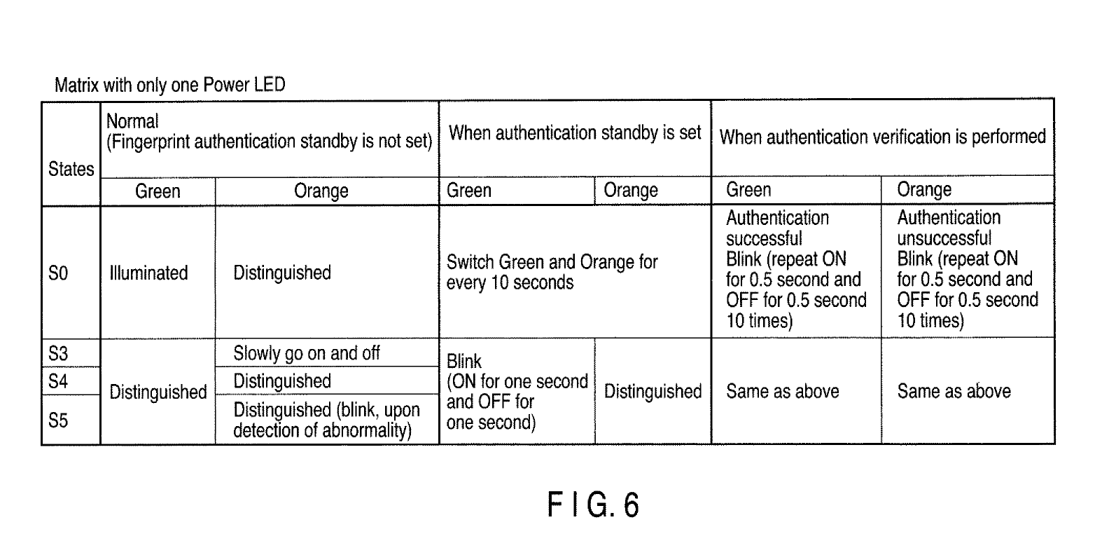

The fingerprint controller IC 25 authenticates fingerprint information of a user input via the fingerprint sensor IC 24 included in the fingerprint sensor 20. The fingerprint controller IC 25 then changes indication patterns of the fingerprint sensor indicator LED 22 and the authentication verification notification LED 23. Changing of the indication patterns of the fingerprint sensor indicator LED 22 and the authentication verification notification LED 23 is performed by changing indication colors to green or red, or making the LEDs to blink. In a personal computer in which the fingerprint sensor indicator LED 22 and the authentication verification notification LED 23 are not provided, the power LED 21 may be used to indicate change of the indication patterns, too (as will be described later; see FIG. 6).

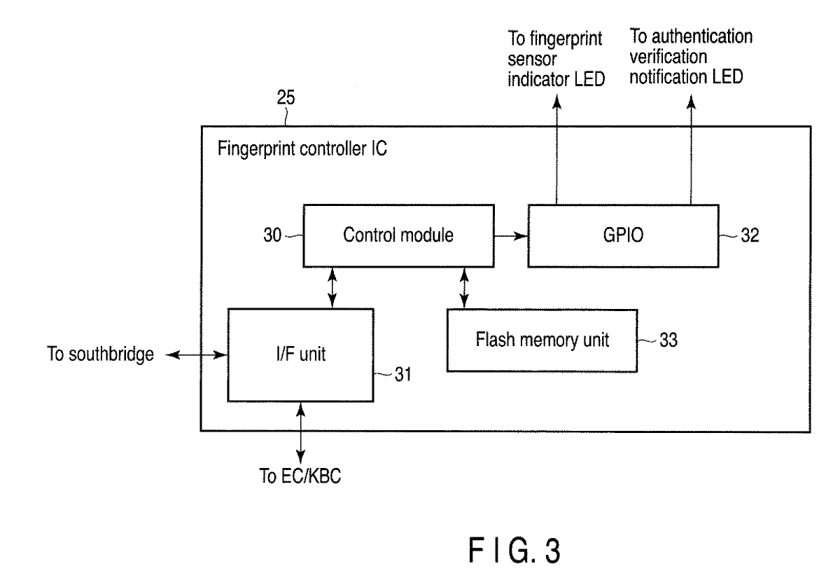

Next, the fingerprint controller IC 25 of the information processing device according to an embodiment of the present invention will be described with reference to FIG. 3. FIG. 3 is a block diagram showing a configuration of the fingerprint controller IC 25.

The fingerprint controller IC 25 comprises a control module 30, an interface unit 31, a general purpose input/output (GPIO) 32, and a non-volatile flash memory module 33. The flash memory module 33 is provided with a firmware mounted thereon and incorporating the user's fingerprint data and a fingerprint authentication algorithm. The fingerprint controller IC 25 comprises a USE controller, for example, and connected to the fingerprint sensor IC 24 via a USB. The controller 30 checks the user's fingerprint data input via the interface unit 31. The interface unit 31 transmits the user's fingerprint data input via the fingerprint sensor IC 24 to the controller 30. A general purpose input/output (GPIO) 32 is a general-purpose input/output port which controls the fingerprint sensor indicator LED 22 and the authentication verification notification LED 23 (by making the LED light, blink, or go out) according to a request from the controller 30.

A wakeup notification signal (such as a signal generated when a user swipes his or her finger) from the fingerprint sensor IC 24 is transmitted via the fingerprint controller IC 25 and the EC/KBC 124 to the system to notify the system of a wakeup request. The fingerprint controller IC 25 receives information about whether a system state (hereinafter also referred to as “state”) of the computer 10 is S0 (i.e., a state where the computer 10 is activated) or S3, S4 or S5 (i.e., a state where the computer 10 is on standby, for example, and not activated) from the system via the EC/KBC 124. More specifically, by using a power line from the EC/KBC 124, which is effective only when the state is S0, to the fingerprint sensor IC 24, the fingerprint controller IC 25 determines that the state is S3, S4 or S5 when the power supply via the power line is interrupted.

The fingerprint authentication utility 200 receives a signal notifying the fingerprint authentication utility 200 of a fingerprint standby (imaging mode) status from the fingerprint controller IC 25, and causes the fingerprint sensor indicator LED 22 to operate (light, blink, etc.) using the received signal. Further, the fingerprint authentication utility 200 receives a signal notifying the fingerprint authentication utility 200 whether the fingerprint has been authenticated or not and causes the authentication verification notification LED 23 to operate (light, blink, etc.) using the received signal. The operation procedures of the fingerprint sensor indicator LED 22 and the authentication verification notification LED 23 are not limited to the above-described ones, and may be modified as long as the fingerprint sensor indicator LED 22 and the authentication verification notification LED 23 can be operated.

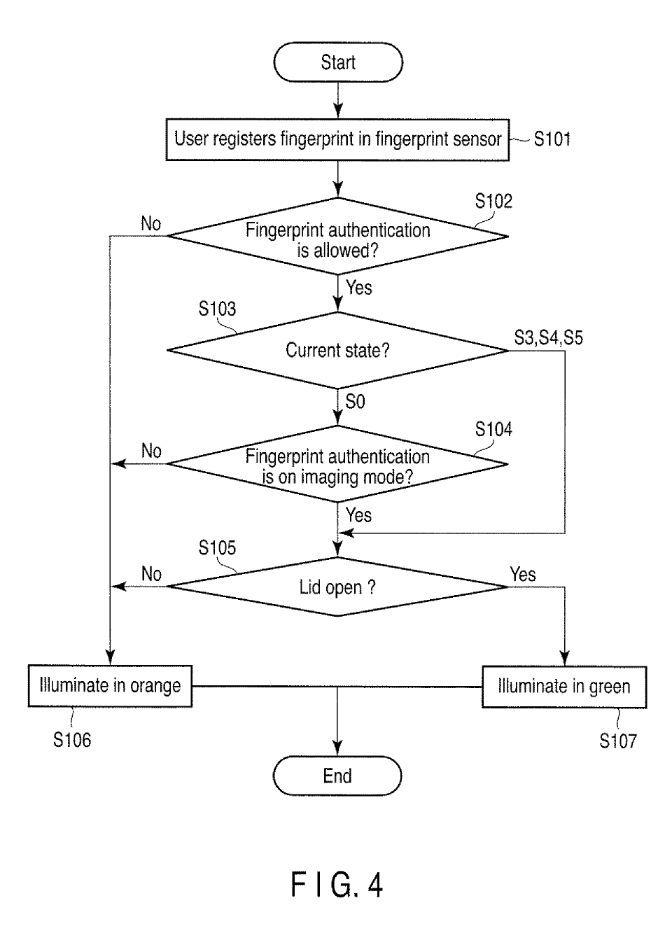

Next, the outline of the indication control method to which the information processing device with the above-described configuration is applied will be described below, with reference to the flowchart shown in FIG. 4.

First, a user swipes his or her finger through a fingerprint sensor 20 (i.e., makes the fingerprint sensor 20 read the fingerprint of the user's finger) to register his or her fingerprint in a flash memory module 33 of the fingerprint sensor IC 24 via the fingerprint authentication utility 200, for example (block S101). Upon registration, the fingerprint authentication utility 200 sets an authentication standby to ON (active). Upon entry of a swipe operation while the authentication standby is set to ON, the fingerprint sensor 20 authenticates the fingerprint. Upon entry of a swipe operation while the authentication standby is set to OFF, on the other hand, the fingerprint sensor 20 scrolls the screen, for example. Determination as to whether the fingerprint sensor 20 is in the fingerprint authentication standby mode or not is based on whether power is supplied to the fingerprint sensor 24 or not. More specifically, when power is supplied to the fingerprint sensor 24, for example, the fingerprint authentication utility 200 determines that the fingerprint sensor 20 is in the fingerprint authentication standby mode.

The fingerprint authentication utility 200 determines whether the fingerprint authentication is allowed or not (block S102).

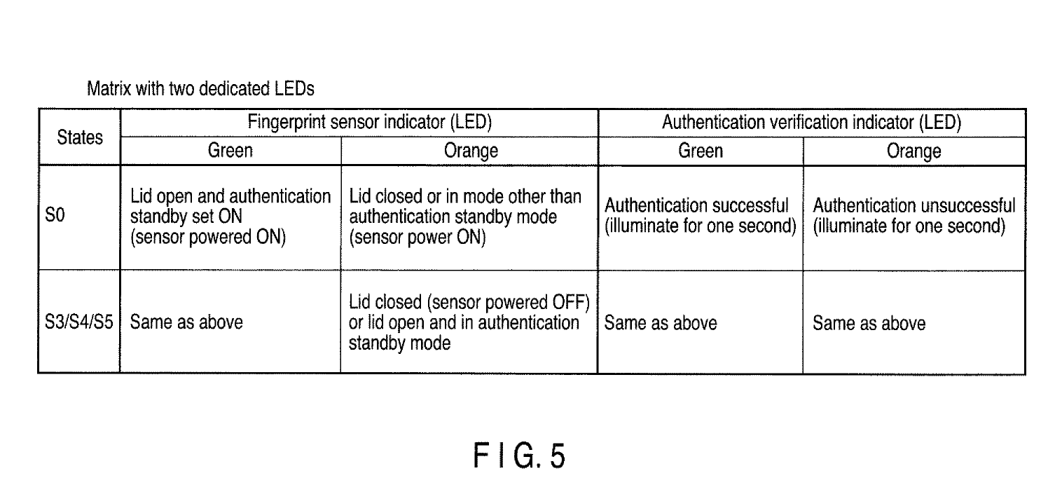

Upon determining in block S102 that fingerprint authentication is not allowed, the fingerprint authentication utility 200 causes the fingerprint sensor indicator LED 22 to light in orange, for example (block S106; see FIG. 5). This state is a mode (such as a navigation mode) other than the authentication standby (imaging mode) and the fingerprint sensor 20 is used to scroll the screen, for example. Upon determining in block S102 that fingerprint authentication is allowed (YES in block S102), the fingerprint authentication utility 200 determines the current state of the computer 10 (block S103). Upon determining in block S103 that the current state of the computer 10 is S0 (S0 in block S103), the fingerprint authentication utility 200 determines whether the fingerprint authentication is on imaging mode or not (block S104). Upon determining in block S104 that the fingerprint authentication is not on imaging mode (NO in block S104), the fingerprint authentication utility 200 causes the fingerprint sensor indicator LED 22 to light in orange, for example (block S106: see FIG. 5). On the other hand, upon determining in block S104 that fingerprint authentication is on imaging mode (YES in block S104), the fingerprint authentication utility 200 determines whether or not the lid is open (i.e., a state where the display unit (lid) of the computer 10 is open) (block S105). Upon determining in block S105 that the lid is open (YES in block S105), the fingerprint authentication utility 200 causes the fingerprint sensor indicator LED 22 to light in green, for example (block S107: see FIG. 5).

Upon determining in block S105 that the lid is not open (i.e., in a state where the display unit (lid) 12 of the computer 10 is closed) (NO in block S105), on the other hand, the fingerprint authentication utility 200 causes the fingerprint sensor indicator LED 22 to light in orange, for example (block S106; see FIG. 5). Upon determining in block S103 that the current state of the computer 10 is one of S3, S4 and S5 (S3, S4, S5 of block S103), the fingerprint authentication utility 200 makes a transition to block S105.

As described above, the illumination colors of the fingerprint sensor indicator LED 22, for example, are changed according to whether or not the authentication standby of the fingerprint sensor 20 is set ON, whether or not the fingerprint sensor 20 is in the authentication standby mode, and whether the display unit (lid) 12 of the computer 10 is open or closed. In a computer in which the fingerprint sensor indicator LED 22 is not installed, for example, the colors are changed according to whether or not the authentication standby of the fingerprint sensor 20 is set ON, whether or not the fingerprint sensor 20 is in the authentication standby mode, and whether the display unit (lid) 12 of the computer 10 is open or closed, using the power LED 21 of the computer 10, for example, as shown in FIG. 6. In a normal mode (in which the fingerprint authentication standby is not set), the power LED 21 is lit in green in state S0, for example, and slowly goes on and off in orange in state S3, for example. In states S4 or S5, the power LED 21 is extinguished, for example. Upon detection of an abnormality in state S5, the power LED 21 is lit, for example. When the fingerprint authentication standby is set ON, the power LED 21 is lit to switch between green and orange every 10 seconds in state S0, for example, and the power LED 21 is distinguished in states S3, S4 or S5, for example.

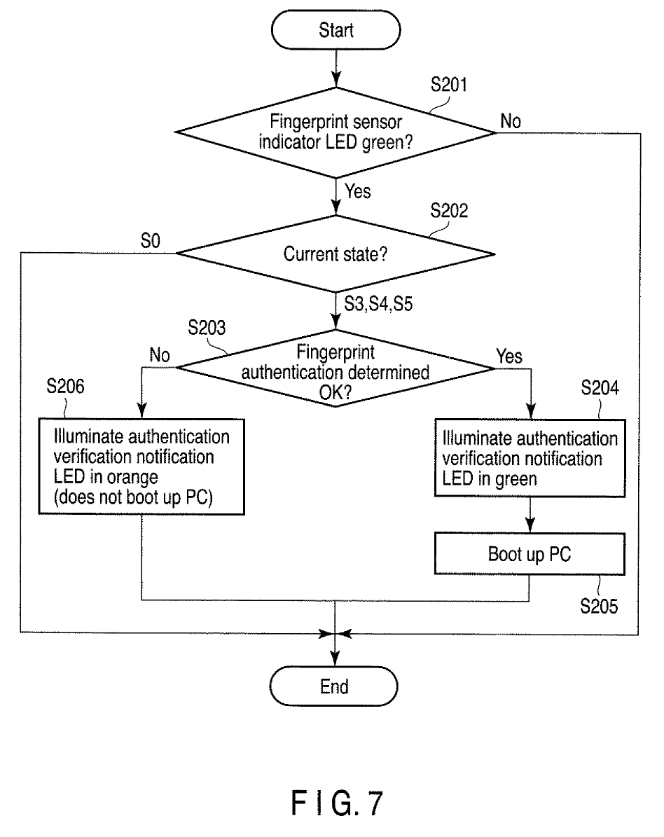

Next, the operation of fingerprint authentication on booting the computer 10 after a user has registered fingerprint data through the fingerprint sensor 20 (one-swipe power-on authentication) will be described, with reference to the flowchart shown in FIG. 7.

The fingerprint authentication utility 200 determines whether the fingerprint sensor indicator LED 22 is green or not (block S201). Upon determining in block S201 that the fingerprint sensor indicator LED 22 is green, the fingerprint authentication utility 200 determines the current state of the computer 10 (block S202). Upon determining in block S202 that the current state of the computer 10 is S0, the fingerprint authentication utility 200 ends the operation. Upon determining in block S202 that the current state of the computer 10 is S3, S4 or S5 (S3, S4, S5 in block S202), the fingerprint authentication utility 200 determines whether or not the authenticated fingerprint is OK (matching) Upon determining in block S203 that authenticated fingerprint is OK (YES in block S203), the fingerprint authentication utility 200 causes the authentication verification notification LED 23 to light in green for one second, for example (block S204; see FIG. 5), and boots the computer (PC) 10 (block S205). Upon determining in block S203 that the authenticated fingerprint is not OK (mismatching) (NO in block S203), on the other hand, the fingerprint authentication utility 200 causes the authentication verification notification LED 23 to light in orange for one second, for example (block S206; see FIG. 5), and does not boot the computer (PC) 10.

As described above, the illumination colors of the authentication verification notification LED 23 are switched according to whether the authenticated fingerprint has been verified by the fingerprint sensor 20. In a computer in which the authentication verification notification LED 23 is not installed, for example, the authentication verification notification LED 23 is changed according to whether or not the authenticated fingerprint has been verified by the fingerprint sensor 20, using the power LED 21 of the computer 10, as shown in FIG. 6. When the authenticated fingerprint is verified in states S0, S3, S4 or S5, for example, the power LED 21 is made to blink in green (by repeating switching between ON and OFF every 0.5 seconds for 10 times).

It is therefore an object of the present invention to provide an information processing device and an indication control method capable of improving user-friendliness by indicating whether or not a fingerprint sensor is operated.

In the above-described embodiment, the user-friendliness can be improved by visually indicating whether the fingerprint sensor is operated or not. That is, the fingerprint sensor 20 is usable in states S3, S4 and S5 in which the computer 10 is not activated, but a display device such as the LCD 17 cannot be used in states S3, S4 and 5. By allowing a user to know whether or not the fingerprint sensor 20 is active, and whether the fingerprint authentication has been verified or not by means of the LEDs, the user can easily know the operation status of the fingerprint sensor 20. Even in an apparatus in which a dedicated indicator module is not equipped, a regularly-equipped power LED, for example, may be used for indication.

Since all the procedures for the control operation of the present embodiment can be realized by software, the same advantage as can be obtained by the present embodiment can be easily attained merely by installing programs to execute the procedures in a computer through a storage medium which can be read by the computer. And a module can be accomplished in software and hardware.

The present invention is not limited to what is described in the above-described embodiment. The present invention can be embodied by modifying the structural elements without departing from the sprit or scope of the invention.

Further, the structural elements disclosed in the above-described embodiment may be combined as appropriate to make various inventions. Some of the structural elements may be deleted from all the structural elements shown in the embodiment. Moreover, the structural elements according to different embodiments may be combined as appropriate.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a fingerprint sensor installed in the housing;
a first and second indicator modules installed in the housing;
a determination module configured to control the first indicator module to change indication patterns according to whether the fingerprint sensor is usable, and determine verification of an authentication entry upon detection of the authentication entry to the fingerprint sensor while the fingerprint sensor is usable; and
a control module configured to control the second indicator module to change an indication pattern when the authentication entry has been verified by the determination module.

2. The information processing device of claim 1, further comprising an openable and closable lid unit attached to the housing, wherein the first and second indicator modules are configured to be visible in a state where the lid unit is closed.

3. The information processing device of claim 1, wherein the fingerprint sensor is configured to be usable in a state where the lid unit is open.

4. An information processing device comprising:
a housing;
a fingerprint sensor installed in the housing;
an indicator module installed in the housing;
a determination module configured to control the indicator module to change indication patterns according to whether the fingerprint sensor is usable, and determines verification of an authentication entry upon detection of the authentication entry to the fingerprint sensor while the fingerprint sensor is usable; and
a control module configured to control the indicator module to change a current indication pattern to a different indication pattern.

5. The information processing device of claim 4, further comprising an openable and closable lid unit attached to the housing, wherein the first and second indicator modules are configured to be visible in a state where the lid unit is closed.

6. The information processing device of claim 4, wherein the fingerprint sensor is configured to be usable in a state where the lid unit is open.

7. An indication control method used for an information processing device comprising a housing, a fingerprint sensor installed in the housing, and first and second indicator modules installed in the housing, the method comprising:
controlling the first indicator module to change indication patterns according to whether the fingerprint sensor is usable, and determining verification of an authentication entry upon detection of the authentication entry to the fingerprint sensor while the fingerprint sensor is usable, and controlling the second indicator module to change an indication pattern when the authentication entry has been verified.

8. The indication control method of claim 6, further comprising an openable and closable lid unit attached to the housing, wherein the first and second indicator modules are configured to be visible in a state where the lid unit is closed.

9. The indication control method of claim 6, wherein the fingerprint sensor is configured to be usable in a state where the lid unit is open.
